(19) United States
(12) Patent Application Publication
(10) Pub. No.: US 2003/0184649 A1
(43) Pub. Date: Oct. 2, 2003

(54) Telemedicine booking station for mass casualty intake facility, relocation center, or the like, arising from bioterror hostage standoff, civil disobedience, or the like

(76) Inventor: W. Stephen G. Mann, Toronto (CA)

Correspondence Address: W. Stephen G. Mann, 284 Bloor Street West, Suite 701, Toronto, ON, M5S 3B8, CA

(21) Appl. No.: 10/113,966

(22) Filed: Apr. 1, 2002

(51) Int. Cl. H04N 7/18; G06F 17/00

(52) U.S. Cl. 348/161; 700/90; 700/213; 348/77

(57) ABSTRACT

Terrorist attacks, threats, or hoaxes, in which there is the possibility of nuclear, biological, and chemical (NBC) attacks, disease, terrorism, civil unrest, disobedience, hostage standoffs, or the like, may require large numbers of victims and suspected cases to be processed through mass decontamination lines prior to mass casualty care. Perpetrators may also attempt to lose themselves in large crowds and hide among the victims, or among bystanders, when the crime scene is cordoned off by the authorities. Accordingly, an evidence collection station is disclosed, along with a method of collecting evidence as victims and suspected cases process through decontamination lines. The evidence collection system preferably includes the collection of videometric and biometric data, along with the tracking of physical evidence recovered from victims and suspected cases. In some embodiments, the facility is automated or remotely controlled, remotely managed, or the like, such as by way of telemedicine, so that at least some ambulatory victims can self-process through the decontamination lines. Various steps are also disclosed for preventing suspected cases from spreading potential contamination by fleeing from the scene. Further processing, especially treatment and possible cure of persons suspected of being afflicted with obedience deficit disorder, are disclosed.

### FIELD OF THE INVENTION

The present invention pertains generally to consequence management or emergency response to terrorist attacks, threats, or hoaxes, such as those involving a possibilitly of nuclear, biological, or chemical contamination.

### BACKGROUND OF THE INVENTION

The applicant is currently assembling the World Mass Deconsortium (WMD) as a consortium of decontamination experts, to address issues of bioterrorism, and related global consequence management and response.

Traditionally, in the event of a suspected release of a nuclear, chemical, or biological agent, the area, city, state, or the like, of the release, is cordoned off to prevent victims, patients, suspects, or others who may be potentially contaminated from leaving the scene of the release without first undergoing decontamination.

Mass decontamination facilities are being built in many hospitals around the world. Two hospitals in Sacremento have decon facilities for cleansing large numbers of patients who have been exposed to chemical agents. The University of Louisville Hospital, which is the primary teaching hospital for the University's School of Medicine, has a technologically-advanced mass decontamination facility featuring an outside entrance with a shower area for washing off hazardous waste. Vanderbilt University Medical Center has a decon facility consisting of 10 shower heads permanently fixed in the ceiling of a sidewalk area outside the Emergency Department. Director Ken Browning estimates a capacity of 200 people per hour.

Additionally, new kinds of decon facilities are being researched, and invented, as described in Canadian Patent 2303611.

Methods of statewide emergency evacuation by the armed forces are also well known in the prior art.

For example, the Model Emergency Health Powers Act allows for entire cities to be cordoned off, in the event of a suspected possibility of a smallpox outbreak, or the like.

Analogous to a suicide bomber, we have now the possibility of disgruntled protesters deliberately infecting themselves:

Some fear that if terrorists got their hands on this supply, they could start a smallpox epidemic with just a single infected person—a “smallpox martyr.”

http://wearcam.org/envirotech/smallpox_martyr_smallpox_supply011018.html

Therefore the victims of a terrorist attack may also include one or more perpetrators. Protestors may simply neglect their own health, or they may even take steps to deliberately impair their own health. Therefore, there may arise a need for law enforcement to cordon off a large area, and provide mandatory decontamination, triage, and health care to unwilling subjects.

The need to corral large numbers of persons who would otherwise flee, is well known in the prior art:

responders would need to corral those trying to flee the scene because exposure to toxic chemicals can cause serious health effects.

http://wearcam.org/envirotech/corral_those_trying_to_flee.htm

Various law enforcement officials, such as Los Angeles Police Department (LAPD) Chief of Police Bernard C. Parks, etc., suggest that force may be required to prevent persons suspected of being contaminated from fleeing the scene of a potential mass casualty event:

Special Weapons And Tactics (SWAT) as a discipline, has long been recognized as “forward thinking” in resolution of barricaded subjects, high-risk warrant service, hostage rescue, . . . . With the advent of year 2000, SWAT is challenged with the potential for response to Weapons of Mass Destruction . . . . Given the recent numerous biological/anthrax threats that have occurred nationally, there is little doubt that SWAT will be pressed into service . . . SWAT should be prepared to accompany non-law enforcement personnel into contaminated areas where there is potential for confronting suspects and to control contaminated persons. The control of contaminated persons who refuse to cooperate with fire department or health services personnel is a serious issue, and the potential for such situations is not only possible but probable . . . units, should have already initiated “arrest and control” training in MOPP-4 equipment . . . security, control of potential suspects, and recovery of evidence . . . serve arrest and search warrants . . . identification, marking, preservation, and custody of evidence inside contaminated areas.

http://www.lapdonline.org/general_information/dept_pub_program/bio_terror.htm cached in http://wearcam.org/envirotech/law_enforcement_control_of_decon_lines.htm

The scene of a chemical or biological agent release, or a suspected release or hoax, is a crime scene. Various methods of preventing victims and suspects from leaving the “hot zone” or crime scene have been proposed:

hose people down both to decontaminate them and to discourage them from leaving the area . . . victims would be given Tyvek suits, spare clothing, or even garbage bags to wear . . . dozens of people could be herded through decontamination lines simultaneously.

http://wearcam.org/envirotech/decon_squad_tyvek.htm

Perpetrators and suspects may be among those present at the crime when it is cordoned off:

suspects may be among the victims treated by the medical system. This further increases the importance of collecting and tracking information on everyone from the incident . . . decontamination to casualties known or suspected of being contaminated . . . some citizens may slip through . . . As victims process through decontamination, they may be found in possession of contraband or weapons

http://wearcam.org/envirotech/decon_bioterror_suspects_contraband.htm

Persons within the site of suspected agent release or social unrest may attempt to conceal certain items on their person or underneath their clothing, or may attempt to destroy certain evidence that they had previously concealed within their clothing.

Civilians carrying unsual items, such as weapons, chemical vials, small containers, survival gear, emergency food rations, or the like, may attempt to dispose of these items when they first become aware that they are contained within a cordoned off area in which decontamination (mandatory removal of clothing) is required.

It should be noted that civilians carrying unusual items such as knives, box cutters, tools, wires, fuses, notepads, etc., may have been in the process of planning a terrorist attack, or organizing some form of social unrest or civil disturbance.

The World Mass Deconsortium therefore recommends that any items such as personal effects that are carried by persons inside the site of unrest be immediately recovered from persons as evidence, before such persons have time to destroy, exchange with others, or otherwise tamper with their own personal effects. Ideally, therefore, a swift control of the population within the zone of unrest is necessary to prevent persons from passing contraband, exchanging personal effects, or communicating with one another. Quick relocation of unruly civilians to unfamiliar areas, along with the breakup of terrorist cells, factions, and public interest groups will reduce their abilities to create further social disturbances.

Persons in the unrest zone may also be carrying evidence of involvement with, or sympathy to lawbreakers. Such evidence can be recovered through the removal of clothing and personal effects.

Moreover, early (immediate) removal of personal effects from all persons within the unrest zone will assist greatly in moving these persons to a relocation center or experimental medical treatment facility. Simply removing a person's shoes greatly reduces the risk of that person fleeing from the incident scene. Moreover, the risk of fight or flight can be greatly reduced by relieving persons of any weapons or survival gear that they may be in posession of:

Fight response mitigation: Prevent fight response by removing weapons from all persons at the unrest site;

Flight response mitigation: Prevent flight response by removing any survival gear, survival clothing, supply of cash or valuables, food rations, or the like from civilians in the area of the unrest site. Flight response includes suicidal or self destructive cases, who may be in posession of chemical agents or other items intended for self-inflicted injury.

The above measures can be best implemented by immediate removal of all clothing, jewellery, and personal effects. Thus immediate decontamination of all persons at the unrest site will not only prevent cross contamination, but will also greatly reduce the possibility of any resistance among the population being contained or relocated.

Triage tags are well known in the prior art, for keeping track of large numbers of persons suspected of carrying disease or suspected of having come in contact with chemical or biological agents, or the like:

It should be noted that no patient should be allowed to leave the exclusion zone without undergoing decontamination procedures . . . to aid rescuers with identifying clothing (evidence) belonging to victims. After a victim's clothing has been removed and placed into an airtight clear plastic bag, the long CONTAMINATED tear off strip is placed inside the bag face out. The numbered tag allows for clear identification of items . . . . The Personal Property Receipt/Evidence tag found at the top of the tag is to be used for identifying valuables removed from victims. (Jewelry, wallets, watches, cash etc . . . ). These items should be collected and placed in a smaller one-gallon clear plastic bag.

http://wearcam.org/envirotech/no_patient_allowed_to_leave_triagetaginstructions.html

While victims are stripped of their clothes, the clothing items, and the initial state of the unclothed victims may be recorded as is well known in the prior art:

The identification of contaminated victims and their personal effects . . . . Victims are also videotaped as they proceed through the decontamination line.

http://wearcam.org/envirotech/victims_videotaped_trough_decon_line.htm

Bus, automobile, and rail transport may be used for transporting large numbers of people. However, surface transportation is inefficient, and also presents containment problems e.g. victims or suspects may escape from a railcar, cattle car, or bus, through windows or other openings, and then flee on foot. Airlines are more suited to the rapid transport or relocation of large numbers of civilians. Airports, therefore, provide a suitable first step in the relocation process. Moreover, security at airports is already higher than it is at bus stations and train stations. Current airport security already in place can screen victims and suspects for weapons and contraband. Also, unlike typical train stations and bus stations, airports already have exit control devices on most doors, to keep people inside. Even if people did manage to break out of an airport building, many of the fields and runways around the airports area already surrounded by high security fences. Thus escape from an airport is already quite difficult.

Some airports of the prior art also have decontamination facilities for large numbers of people:

Ontario International Airport, Ontario Calif., has become the first airport in the nation to get a high tech portable mass decontamination system. The system manufactured by Modec Inc. of Denver can process up to 700 persons per hour. The portable unit can be easily set up in under thirty minutes. The Los Angeles World Airports which owns and operates Ontario International bought three of the $220,000 mass casualty decon systems and gave the first one to the Ontario International Airport. The project under the direction of Mr. Michael DiGirolamo, Director of Airports Operation Los Angeles City Dept. of Airports, and was coordinated by Mr. Richard Taylor, Disaster Preparedness Coordinator for the Los Angeles City Dept. of Airports . . . . Men and women would go through different compartments. After the showers, they would have to wear paper suits until uncontaminated clothing could be brought to them. Personal belongings would be decontaminated separately, and some items may have to be destroyed, DiGirolamo said.

http://www.arffwg.org/arffwgnews/success/deconsuccess.htm

An airport can easily process ten thousand people in a mechanized and very efficient way:

The disinfection/decontamination process is akin to “putting humans through a car wash” after first destroying their garments. Los Angeles World Airports have put in place a contingency plan to disinfect up to 10,000 persons who might have been exposed to biological or chemical substances.

http://wearcam.org/envirotech/putting_humans_through_a_carwash_after_destroying_garments.htm

Special considerations for assistive devices have also been considered in the prior art:

Eyeglasses suspected of being contaminated and not required for safe evacuation should be placed in a plastic bag and carried to the decontamination station. All contact lenses suspected of being contaminated should be placed in a plastic bag and carried to the decontamination station, b. removal of all external extraneous items from contact with the body. Such items include hearing aids, artificial limbs, jewelry, watches, toupees, and wigs,

http://wearcam.org/envirotech/decon_eyeglasses_contact_lens_cutoff_undershirts_App_L.html

After thousands of civilians are relieved of their clothing and personal effects, the personal effects and the persons themselves are placed in bags, the persons themselves being placed in garbage bags:

. . . dress in large trash bags with holes cut out for the head and arms.

Since a suspected terrorist incident constitutes a crime scene, all clothing removed from victims will be evidence. This means the clothing needs to be bagged, tagged for later victim identification (like triage tags) and set aside in a secure location until the Federal Bureau of Investigation (FBI)—the lead law enforcement agency—determines its disposition.

11. http://wearcam.org/envirotech/victims_clothing_as_evidence.htm

Persons may need to be apprehended if they are suspected of having come in contact with a person who might have been carrying a disease. Such contact tracing is known in the prior art. Apprehension of persons suspected of being infected is also known:

provide for the apprehension and examination of any individual reasonably believed to be infected with a communicable disease in a communicable stage

http://wearcam.org/envirotech/apprehension_and_examination_of_disease_suspects42USC264.htm

The use of flexcuffs for handling large numbers of displaced civilians is known in the prior art:

During a review of several recent incidents specifying an anthrax threat, where no live spores were found, it was noted that potentially contaminated and displaced persons were quite upset about being “inconvenienced” with detention and quarantine procedures . . . . What about the control of uncooperative, contaminated subject(s) at the scene? Based upon health department direction to law enforcement to “quarantine” persons exposed to biological/chemical agents, how much force should be used to prevent persons from leaving the scene and potentially contaminating others? . . . restraining devices (flexcuffs, etc.) will quickly establish control over the situation . . . . About the Author Captain Michael Hillmann is the commanding officer of LAPD's West Los Angeles Area.

http://wearcam.org/envirotech/control_of_uncooperative_contaminated_subjects_bio_terror.htm

Riot control is well known in the context of mass decontamination:

Emergency planners should be aware that the release of any CW/BW agent is likely to induce a psychological reaction on the part of a largely unprotected civilian population, and that problems with crowd control, rioting, and other opportunistic crime could be anticipated . . . the need for rapid and thorough decontamination is mandatory. It is strongly recommended that no contaminated person or vehicle be allowed to leave the scene of a chemical release . . . .

http://wearcam.org/envirotech/no_contaminated_person_allowed_to_leave.htm

Gym showers have been proposed for processing large numbers of sightseers, residents, business employees, customers, etc.:

People to be considered include casualties; bystanders and sightseers; military and civilian response personnel; and residents, business employees and customers in the contaminated area . . . Therefore, a gym or other facility with dressing rooms and high capacity showers may be appropriate for processing people.

http://wearcam.org/envirotech/gym_high_capacity_showers_for_processing_people.htm

Persons suspected of having been exposed to some white powder, or the like, may also be rounded up and sent to college showers where their clothing, books, cellphones, and the like, maybe be confiscated:

Everyone who walked through the east-west corridor . . . was rounded up . . . Those who might have been exposed to the powder were bused to the college's athletic center. There they were stripped of their clothes, books, backpacks and cellphones, all of which were confiscated.

http://wearcam.org/envirotech/athletic_center_stripped_confiscated20011101mercyhurst1101p3.htm

The confiscation of clothing, wallets, keys, etc., from large numbers of people, is well known in the art:

TOWARD A NATIONAL STRATEGY FOR COMBATING TERRORISM . . . The victims' decontamination process entailed their being stripped and scrubbed down with a diluted hypochlorite (bleach) solution. Their personal effects (e.g., clothing, wallets, keys, etc.), considered both contaminated and evidence, were confiscated and sealed. These items could not be unsealed and/or released until their safety had been confirmed.

http://wearcam.org/envirotech/anthrax_victims_personal_effects_confiscated.htm

The use of force to contain a civil population is also well known:

contain a civil population with force in the event of an attack using a highly infectious agent.

http://wearcam.org/envirotech/contain_civil_population_with_force.htm

Marking the bodies of people on the chest or forehead has also been proposed:

writing directly on the chest or forehead with an indelible marker) with an indication of the specific treatment that was applied to the individual and the time at which decontamination was completed;

http://wearcam.org/envirotech/decon_eyeglasses_contact_lens_cutoff_undershirts_App_L.html

Decontamination centers at secret locations, with the ability to run people through a central intake facility, are also known in the art:

The city has taken steps to establish decontamination centers at various undisclosed locations, he said. “The equipment is in place . . . “We have to be able to shut down the hospital, filter people through a central intake where we can shower and wash them down,”

http://wearcam.org/envirotech/decontamination_centers_at_undisclosed_locations.htm

The use of showers as a means of searching people for weapons or contraband is well known in the art, as is practiced, for example, in the context of homeless shelters, or, in the treatment of alcoholics:

Personal property is collected and bagged for later collection and all clothing is taken and washed and dried. This procedure also ensures (albeit discreetly) that weapons and alcohol are not taken into the shelter.

Best Practice in the Diversion of Alcohol and other Drug Offenders

http://wearcam.org/envirotech/bagging_clothes_discrete_weapons_check.htm

Decontamination goes hand-in-hand with the increased emphasis on hygiene. Intelligent plumbing systems may contain cameras built into the plumbing systems. Such systems have been proposed for employee surveillance, or the like: surveillance:

Abstract An apparatus and method for monitoring hand washing wherein a subject's hands are checked after he or she has applied soap or detergent and spread it over the front and back of his or her hands. An optical image of the subject's hands is digitized and compared, pixel by pixel, with a reference feature that distinguishes the soap and a report is generated indicating whether the subject's hands are covered with enough soap or detergent to receive a satisfactory report.

U.S. Pat. No. 6,038,331

International Business Machines (IBM) has proposed the installation of video surveillance cameras in shower stalls, surveillance cameras in toilets, and in other places such as workplaces, in order to inspect people to see if the people look like they might be in poor health, and to automatically report suspected poor health to the appropriate authorities:

Abstract The invention detects signs of emerging illness, such as flu, skin cancer, backache, etc., among the general population and individuals. The detection of symptoms of illness is performed through the utilization of embedded devices equipped with various sensors, such as cameras, glasses, wrist watches, TVs, fire warning systems, and having the ability to analyze the detected information and to transmit that information via wireless and regular communication channels to a central server for a more detailed analysis and possible action. The information about locally detected symptoms is gathered at central location and processed to ascertain whether there is a new epidemic of a flu, therefore enabling early shipment of a flu vaccine which prevents the spread of the disease. . . . Another example of the placement of the embedded devices may be a target individual's bathroom. A camera with an embedded device having a processor programmed to take daily images of the target individual's skin regions while the target individual is habitually following a toilet routine. The daily images of same skin regions are then compared to detect changes signaling skin cancer concerns. Furthermore, this locally embedded cancer detection system may pass gathered information to a central server for a more complex analysis of detected symptoms and for the purpose of collection of statistical data. The central server may have the ability to collect statistical data from many reporting locations thereby having an ability to associate cases of disease with possible regional and global environmental factors.

U.S. Pat. No. 6,238,337

In U.S. Pat. No. 6,360,181, Kimberly-Clark Worldwide, Inc. describes systems for covertly monitoring washroom users in order to obtain marketing information . . . .

More specifically, this invention involves an improved system and method for collecting data on individual and aggregate usage of washroom products in a manner that is not detectable to persons who are using the product. . . . For example, data relating to factors as the total amount of paper used, the duration of time over which paper is used, the number of discrete pulls on the paper taken by a user and the amount of paper taken by a user per discrete pull would be very helpful for both marketing and engineering purposes. . . . When collecting this type of information, it is important that consumers not know their activities are being monitored, since this may change their behavior. In addition, some consumers might become apprehensive at the thought of being monitored in this manner . . . obtaining information on consumer tissue preferences and habits that is accurate, efficient and substantially undetectable by consumers . . . monitoring the person's use of the paper product in such a manner that the person is not aware of such monitoring

Intelligence-gathering systems, means of controlling large numbers of people, etc., can also be applied to the management of a large-scale involuntary labour force. Means and apparatus for compelling civilians to perform mandatory work is well known in the art:

Other outstanding legal questions concern the ability to isolate, quarantine, or detain groups or individuals; the ability to mandate treatment or mandate work; restrictions on travel and trade; the authority to seize community or private property such as hospitals, utilities, medicines, or vehicles; or the ability to compel production of certain goods.

Testimony of Margaret A. Hamburg, M. D. Subcommittee on National Security, Veterans Affairs And International Relations Committee on Government Reform Jul. 23, 2001 cached in http://wearcam.org/envirotech/mandate_work101701hamburg.htm

The commandeering of private property, of labour forces (and therefore the human body itself), is also well known in the art. It has been proposed, for example, that a luxurious beach resort could be built as a detention area for persons suspected of carrying disease:

we just want to ask people who have the symptoms to join us at the most luxurious beach resort we can find, around which we are going to throw a ten-foot wall, reinforced by guards with nonviolent means of stopping people who want to leave.

cached in http://wearcam.org/quarantine_luxurious_beach_resort_walled_guards.htm

The commandeering of the human body is also well known in the art:

EXECUTIVE ORDER 11000 ( 27 F.R. 1532) allows the Secretary of Labor to “mobilize” civilians into work brigades under government supervision.

cached in http://wearcam.org/fema_america.htm

Means and apparatus for the relocation, whether by cattle car, or aircraft, of individuals to beach resorts, detention facilities, fine camping grounds out in the countryside (quarantine camps, detention camps, etc.) is well known in the prior art.

### SUMMARY OF THE INVENTION

Accordingly, the present invention in one aspect comprises a camera bearing health care booking station for intake of disease suspects or the like, where the suspects are required to remove all clothing, jewellery, and personal effects for evidence gathering or decontamination purposes. The booking station preferably contains one or more video surveillance cameras to record the suspect in various stages of undress, so that the articles of clothing being collected are properly documented in the manner in which they are ordinarily worn by the suspect. Booking stations of the prior art, such as those used to book criminal suspects, allow for computer data entry of keywords to describe articles of clothing, or may even provide means for entering pictures of clothing articles, but do not provide a systematic way in which a suspect can be documented while being stripped down.

The booking station preferably also additionally provides a clothing scanner to scan items removed from the suspect's body. For example, the suspect is photographed fully clothed, and then photographed while the suspect removes outerwear for scanning. The outerwear is scanned, and the scans are entered into a database together with pictures of the suspect wearing that same outerwear. In this way, the database contains pictures of each article, together with pictures of the manner in which each article was worn by the suspect. Next the suspect is photographed in the suspect's underwear, after which the underwear is removed for scanning, so that there are pictures of the underwear itself as well as pictures of the suspect wearing the underwear.

The booking station prints out a barcode for being attached to each article of clothing, so that each item can be tracked and associated with pictures of the item. Later these items can be viewed through eyeglasses that contain a computer display screen, so that officials viewing the article of clothing can see a picture of how the clothing was worn, said picture popping up automatically when the eyeglasses (which also contain a scanner or camera) recognize the barcode.

Preferably the booking station will also capture images of the suspect's body after the removal of all clothing, so that the health of the suspect is recorded at the time of apprehension. Such evidence may assist in claims of physical abuse later made by the suspect, or in issues of liability arising from matters concerning the suspect's health. Moreover, the body of the suspect may provide important clues to the suspect's identity.

Thus if a suspect claims that he or she was beaten by guards, or tortured or suffered loss of health while being detained, the pictures may be used by the authorities as evidence with which to, for example, show that certain marks were on the suspect's body at the time of apprehension.

Full body scans of the suspect can also help in documenting the absence of injuries such as cuts, abrasions, bruises, and the like, that might otherwise form the basis for false claims of police brutality.

Booking systems of the prior art include means for entry of fingerprints and pictures of any Scars, Marks, or Tattoos (SMT) on the body of the suspect. However, an important aspect of the present invention is an SMT-finder and SMT scaler. The SMT finder uses computer vision to analyze images of the suspect's unclothed body, to locate any Scars, Marks, or Tattoos. These are found automatically, so that computer controlled imaging systems can photograph each of them close-up and in detail. Also the booking system of the present invention provides full-body images even if no Scars, Marks, or Tattoos are found. Therefore the booking system can collect important evidence of the absence of SMT.

Booking systems of the prior art provide for the data entry of SMT pictures but without context.

In the present invention, the SMT images are indexed to full-body pictures so that the context of each SMT image is given. The data is presented in context, by hyperlinks. Preferably the booking station captures multiple full body images, e.g. a frontal picture, and back picture. A chest tattoo might, for example, be visible in the frontal picture. Clicking on this area of the body will cause a close-up picture of the chest tattoo to appear.

Preferably a three dimensional (3d) body scan is also made, so that the body can be loaded as an object, and analyzed on the computer screen. The object may be moved around and viewed from any angle. Clicking on any of the Scars, Marks, or Tattoos that appear on the body will then cause a closeup image of the particular feature in question to appear.

Images are captured and automatically entered into a hypertext document so that the above effect can occur. An image map is constructed, and associated with the full body image(s) of the suspect. The features (SMT, or the like) are each associated with

In another aspect of the invention, a system for processing large numbers of people, while accounting for personal effects (clothing, valuables, etc.), as well as preserving evidence, is disclosed.

In another aspect of the invention, suspects can self-process through the booking lines. self booking, fingerprinting, etc . . . In this case, the invention provides a Booking Management System, where the booking management system allows suspects to fingerprint themselves, in an information kiosk, in which they are given the opportunity to also scan themselves and their clothing and personal effects after they have removed their clothing, jewelry, and other personal effects in order to process themselves through decon.

In another aspect of the invention, especially in the event of a bioterror attack, there may be large numbers of ambulatory suspects needing processing. Accordingly, an automated processing facility in which the majority of suspects self-process will allow law enforcement and emergency responders to concentrate their efforts on a smaller number of suspects who are unable or unwilling to self-process. In this way, individuals can voluntarily demonstrate to the authorities that they have nothing to hide. Individuals who thus demonstrate that they have nothing to hide can be given favorable treatment, and can be the first to be processed and released from the incident site. Being among the first to be released to hospitals, or back into the community, will be an advantage for which many will chose to self process. Persons suspected of having come in contact with a disease, or persons suspected of being in poor health, or in an incipience of a possibly contagious stage of a disease, may be detained as they self process through decon.

In another aspect of the invention, a luxury beach resort is provided as an initial screening and observation area, in order to determine the physical, mental, and cooperational health of suspects. Suspects are transported to a nice beach resort or spa facility, where they can recuperate, not just so that their health can improve, but also for the purpose of providing authorities with an opportunity to observe the behavioural patterns and tendencies of such persons. The beach resort or spa is fitted with numerous video surveillance and monitoring capabilities, to determine how various people behave in social settings, and how they interact with and respond to others in the resort. Those persons bahaving normally may be determined to be of sound mental health, and are then eventually allowed to leave, whereas those who behave strangely, or in a disrespectful or disobedient manner, can be later sent to a quarantine camp or other detention facility. Thus the transfer of all suspects to the initial beach or spa resort gives the authorities an opportunity to to clear out and stabilize and observe and separate troublemakers from the rest of the more cooperative population. Close surveillance with hidden cameras and microphones within the spa or beach resort allows subversives and political activists to be separated from those having a more normal and obedient outlook.

Within the quarantine resort of the invention, there are preferably various forms of health surveillance, starting with a mandatory vaccination and implant (tracking device) to ensure the safety of the detainees, to various health monitoring to ensure the health of the detainees. Sanitary fixtures and handwash fixtures are equipped with tracking devices, to monitor, enforce, and maintain hygiene. Showers in relocation centers also provide monitoring, scanning of the body to provide health records, and the like, as well as contraband detection and removal. Sanitary fixtures such as toilets with defecographic function, further assist in data collection, data being integrated with health management of the detainees.

In one embodiment detainees are given a choice of two or more sanitary facilities, such as may be provided by a choice of two toilet rooms that the detainees can use. In one toilet room there is provided health monitoring functionality, such that detainees can choose whether or not to participate in the health monitoring program by simply using the facility so equipped. It may also therefore be determined which of the detainees have nothing to hide and are interested in maintaining good health.

Such choices as an experimental framework can therefore automatically categorize detainees according to their willingness to participate in efforts for improved health.

Other diseases, such as Obedience Deficit Disorder (ODD) are also dealt with, within the scope of the invention. Since ODD is highly contagious, it is important to be able to quarantine those afflicted by such a disease or disorder. While electroshock therapy is useful in the temporary reduction in ODD, a more lasting effect may be provided by way of a wearable or implantable apparatus of a nature that it cannot be easily removed by the subject. A therapy field is established, as a numerical value of shock therapy level, such that the field varies spatially, conceptually, or behaviourally, over a space of defined position, concepts, or behaviours. Thus if it is desired that the patient be moved from one room to another, an electroshock therapy level from the apparatus of the invention can be made to actuate on one side of the body. To move the patient forward, a therapy from behind is provided. To move the patient to the right, a therapy from the left is provided, and so on. Thus an array of actuators, electrodes, or the like, can be used to cure a patient suffering from ODD.

After processing through decon, and being sent to the beach resort or spa, for close observation, it will be easily found which patients are afflicted with ODD. Those patients can be fitted with the device. Preferably the device is in the form of a belt, vest, or other similar garment secured to the body such that the subject cannot remove the device. Wireless communications is used to recieve off packets. Off packets cause the device to remain off. An array of actuators receive off packets. In a preferred embodiment there are four actuators, back, front, left, and right, each receiving off packets to keep them turned off. To effect therapy, one or two of the off packets are attenuated, so that they are not received by the device, or are weakly received. To conrol the direction of the therapy, the off packets are attenuated for data codes corresponding to each of the four actuators.

Of course if the patient strays away from the beach resort or spa, the signal becomes weak, and all four actuators begin delivering therapy.

The apparatus can be combined with video surveillance as well as with a wearable camera outfitted into the apparatus itself. This allows for a closed-loop therapy session using computer vision.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 is a diagram showing a self-processing decontamination triage telemedicine and quarantine intake facility.

FIG. 2 is a diagram showing a prosthetic device for correction of Obedience Deficit Disorder (ODD).

FIG. 3 is a diagram showing a disease outbreak containment system.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

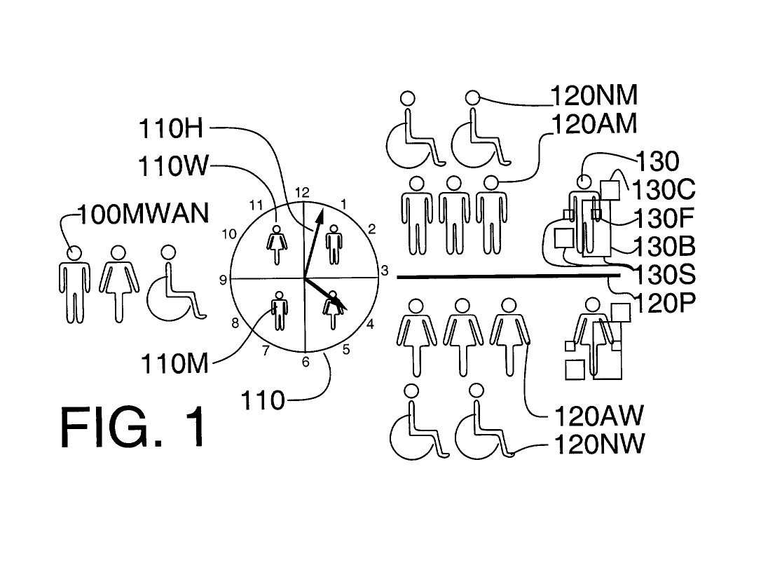

FIG. 1 shows ambulatory and nonambulatory men and women suspects 100 MWAN. The semantographic figures signifying men and women are similar to Charles Keisel Bliss' figures employed to indicate men's and women's washrooms,

exemplify generally perceived properties of masculinity and femininity.

Indeed, rounded, closed shapes as well as triangles pointing upward have been shown universally to indicate femininity, whereas the opposite shapes stand for masculinity.

http://home.earthlink.net/crockford/blissbib.html as developed at the Blissymbolics Communication Institute, in Toronto, founded in 1975, and further described in Bliss, Charles Keisel. The Blissymbols Picture Book. Semantography Press: Sidney, 1984, and

The term “suspect” denotes persons who may have been perpetrators, victims, or merely bystanders of a suspected terrorist incident, or suspected presence of the possibility of a disease. Suspects are persons suspected of having been exposed to chemical agents, or persons suspected of being diseased, or persons suspected of having perpetrated a criminal activity, or of having been sympathetic to, or helpful to, a criminal cause. Thus, for example, if a white powder is found in a building, suspects may include all those persons present in the building, because persons present on the building might have breathed in some air from the ventilation system in the building that might have been contaminated by way of the white powder, notwithstanding the fact that the white powder could be anthrax, or merely table salt, icing sugar, or chalk dust.

Suspects 100MWAN self organize on opposite sides of a privacy barrier 120P. Privacy is indeed a very important element of modern society. The expectation of privacy, and the need for modesty, is of utmost importance. Therefore, separate decontamination, triage, and triometric (triage biometrics) areas are needed.

Ambulatory men 120AM and nonambulatory men 120NM organize onto the men's side of the privacy barrier 120P. Ambulatory women 120AW and nonambulatory women 120NW organize onto the women's side of the privacy barrier 120P.

Each side of the barrier facilitates a lineup, stripdown, and booking procedure. Without loss of generality, we consider the men's side, where men strip, self book, and provide evidence on an initially voluntary basis. Suspect 130 steps forward to a booking station 130S. The booking station 130S has one or more surveillance cameras 130C to document and record the amount of contaminant on the clothing of suspect 130. For example camera 130C might capture and record the fact that suspect 130 had a mysterious powder present on his clothing. Preferably camera 130C is a multispectral camera, or comprises a plurality of optical instruments operating in multiple spectral bands, so that certain bioterror agents can be detected. A bagging device 130B accepts clothing from the suspect. The suspect first removes outer clothing, for placement in the bagging device. The bagging device is oriented in such a manner as to facilitate evidence gathering and chain-of-custody capture. Preferably an additional overhead video camera captures chain-of-custody data, so that the clothing chain of custody is documented, to provide evidence that there was no tampering with the clothing prior to bagging as evidence for later collection by law enforcement or the lead agency. As the suspect peels off each layer of clothing, he is photographed, so that the extent of agent penetration through various layers of clothing can be determined. Alternatively, a continuous or near continuous video record can be captured. A visual dataset is therefore established to show the various stages of undress. For example, the visual dataset may show a chemical agent on the suspect's outerwear, while showing that the agent has soaked through to the suspect's sweater, but that the agent has not soaked all the way through to the suspect's undershirt. Such information is valuable evidence.

Moreover, since the scene of a terrorist biological or chemical release is a crime scene, the visual dataset will assist law enforcement in establishing the manner in which each article of clothing was typically worn by the suspect, as well as the manner in which the suspect appeared at each stage of undress. For example, the process will capture a full frontal picture of the suspect's body, including the face. Therefore, law enforcement will have access to the manner in which the suspect appeared both with and without eyeglasses.

Finally, capture of the suspect's unclothed body will show evidence of any anomalities, such as cutaneous anthrax, skin rash, evidence of smallpox, or other disease, or the lack thereof. Moreover, the final images captured after suspect 130 has completely stripped down will show any Scars Marks or Tattoos (SMT), or the lack thereof. Thus if the fullbody images do nothing more than simply show that there were no SMT on the suspect's body, the apparatus will have still provided valuable evidence to law enforcement.

Preferably a suspect scanning platform also captures footprint images of the suspect with and without shoes. This will provide both shoeprints, as well as barefoot footprint image capture.

Additionally, fingerprint scanners 130F allow the suspect to issue himself an electronic clothing claim check. Retinal or iris scanners are also provided, to provide additional information together with a DNA sampler.

An additional clothing scanner platform, or simply a flat table with overhead camera allows suspect 130 to scan each article of his clothing as he removes it from his body. Keys, wallet, and other items are similarly scanned. The suspect 130 counts out his cash, from his wallet, onto the table to document exactly how much cash, what bills, and what serial numbers were on these bills.

After stripdown, the suspect activates a spray/deluge shower, by pressing two hand grips, containing fingerprint scanners 130F. The deluge shower happens inplace, so that the camera 130C can also be used by remote decon officers to monitor the decon process.

The decon deluge shower has the added benefit of cleaning the station 130S for the next suspect.

Preferably immediately after the deluge shower, which provides a sterile environment, suspect 130 self-implants and self-vaccinates, through a vaccination/implant feature of the station 130S.

Suspects who have nothing to hide will very likely be willing to strip down and reveal everything, wheras perpetrators who are pretending to be victims or bystanders will be less than willing to strip down.

Those failing to volunteer to process through the voluntary strip-and-scan facility may be detained for later compulsory booking and further detention, whereas cooperative men are whisked away quickly to a luxurious beach resort where they have no chance of infecting others but live under favorable conditions for a sufficient time period to test samples for bioterror agents, examine evidence, ascertain the identity of perpetrators, and control the incident. Men found to be free of disease, suspicion, or guilt, are then released.

After suspect 130 has stripped down, his privacy must be protected. Absolute privacy is provided by a privacy scheduler 110. In one embodiment, privacy scheduler 110 is a clock, with a hand 110H (the minute hand) defining four quadrants, of the hour, into 15 minute intervals. The first interval is for men, the second for women, the third for men, and the fourth for women.

Suspect 130 is assured absolute privacy by way of selecting a temporal quadrant 110M for men. This quadrant may, for example, be a boarding quadrant for boarding the next men's flight to the men's beach resort or quarantine spa facility.

Image capture of the suspect 130 in various stages of undress, including in a state of complete undress, creates a need for privacy. Absolute privacy is guaranteed through strong encryption of the visual dataset so that only decontamination officers, law enforcement officers, quarantine facility managers, medical professionals, and the like can observe this image data.

Nonambulatory men 120NM process through a nonambulatory decon line on stretchers, or boards.

Finally, uncooperative men who were not willing to self process are restrained to stretchers, boards, or the like, and have their clothing cut off, in a similar manner to the nonambulatory patients, but with the added constraint of the restraints. Unfortunately the restraints make it more difficult for the authorities to cut the clothing off, so the uncooperative nonambulatory patients (rendered nonambulatory by restraints) will have a much harder time than the cooperative nonambulatory patients.

In the event that the uncooperative suspect's skin is also cut while clothing is being cut off, first aid staff should be present to control the bleeding. Alternatively, a drug-based restraint may be applied, to render the suspect sufficiently docile as to be safely stripped down.

Because of the possibility of altercations, security cameras are used to capture the various stages of the bagging and decon process. Remote monitoring may also be applied, for example, to ensure that suspects shower sufficiently thoroughly after stripdown.

Booking station 130S is preferably on a stand or kiosk, so that it can sense the presence of a suspect, and automatically photograph the suspect on arrival, so that there is a record of the exact condition of the suspect and the suspect's clothing, as worn by the suspect, in the initial condition in which the suspect arrived. Suitable sensors comprise a pressure sensor in the floor, to sense when and where the suspect is standing, and to wait for the best time to capture the suspect's clothed-body image. Preferably there is at least a full frontal and full back shot, as well as a profile view, all three being captured at the same time.

Booking station 130S typically comprises a multimedia computer that displays evidence cataloging and stripdown instructions to the suspect, so that the suspect can follow a simple set of instructions. These might for example, read: “remove everything from your pockets and place in the small receptacle”. As the suspect does this, the small receptacle senses the items inserted, and scans these items in the exact condition in which they were inserted. Sensory systems such as a localizational metal detector, ensure that this first step is complied with, otherwise prompting the suspect to ensure that ALL items are removed from pockets and placed into the first receptacle. The computer displays instructions for scanning of paper bills, credit cards, passport, or any other items the suspect is in posession of. Since these items could be, for example, false identification, self-processing of suspects scanning their own personal effects, in the presence of security cameras, will greatly assist in chain-of-custody evidence collection.

After the computer senses completion of the first task, the computer next displays undressing instructions, including clothing scanning instructions. The suspect is promted to remove shoes, scan the soles, and insert into a second receptacle. Next the suspect is prompted to remove outerwear for scanning. The suspect is then automatically photographed to document the appearance of the suspect when wearing underwear, and to document the manner in which the underwear is worn, as well as the condition of the underwear at the time of suspect processing (e.g. if there is chemical agent present on the underwear, if there are signs of incontinence that might have indicated a head injury, and if any torn cloth matches the position of any wounds, cuts, scrapes, or the like, so that later claims of injury can be substantiated).

The computer then displays instructions for the suspect to remove and scan the underwear. The suspect's unclothed body is then photographed to capture any identifying marks, document any scratches, bruises, skin damage, or chemical agents that might be present on the skin surface.

A high capacity embodiment of the invention will comprise separate booking stations for men and women. Further increases in capacity are possible by running multiple stations in parallel. For example, six stations on the men's side and six stations on the women's side will result in suspects being processed by the dozen.

In an alternative low-capacity embodiment of the invention, a single kiosk used alternately by men and women, or alternately by groups of men and women, may be used.

In another embodiment, a bank of kiosks operate in parallel, and are used by men for 15 minutes, then by women for 15 minutes, and so on, alternating by gender every 15 minutes, in accordance with a privacy scheduler 110. In this embodiment, suspects 100MWAN first encounter the privacy scheduler, then self process and then board. For example, men step forward from a line of suspects 100MWAN, self process in parallel, and then board a men's flight, all within a 15 minute time interval. Women step forward in the next 15 minutes and self process, then board a women's flight.

The entire facility can be run remotely by remote medical staff who can perform telemedicine en-masse, through group examinations of groups of men or women.

The remote staff can also select certain individuals to be commandeered. Thus in addition to commandeering personal property, the authorities may also wish to commandeer corporeal assets, such as for production of a labour force following physical examinations. Moreover, the commandeering of a reproductive force may assist in ensuring future defense against terrorism. Remote staff select optimal samples from the sample population of suspects, and commandeer reproductive samples from men as they self process through decon. On the women's side, physical restraints may be applied for insertion of said samples as appropriate for the necessary commandeering of labour force production and reproduction.

Thus the commandeering package is made complete from personal property, labour force production, and reproduction, to ensure a strong defense against terrorism.

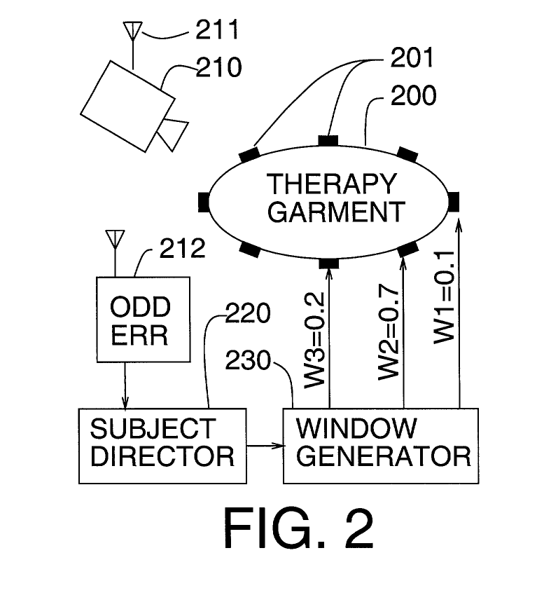

FIG. 2 shows a prosthetic device for assisting docility-challenged individuals, or those suffering from Obedience Deficit Disorder (ODD).

Since many chemicals and bioterror agents released by terrorists cause psychosis or other mental disorders, it is expected that a terror attack could cause a large number of casualties suffering from mental illness or other instability. Terrorists can inflict disorder, chaos, and thus even the “worried well” may outnumber the actual casualties. This may result in riots, looting, and general civil disobedience arising from widespread paranoia. Thus there is a need to handle large numbers of docility-challenged victims.

Accordingly, ODD persons are fitted with a secure safety garment 200 that they cannot easily remove, or that is fitted with disincentives to removal. The garment contains stimulators 201 for providing stimulus. Preferably stimulators 201 comprise electrical stimulators providing pulses of electricity having peak voltages on the order of 50,000 volts, but sufficiently low current as to not cause death to the wearer.

Although only eight stimulators are shown, a stimulus direction can be generated by having a window generator 230 that allows for sub-stimulator resolution. Thus a coarse array of stimulators can give rise to a much finer array of directions. A Gaussian window, hamming window, hanning window, or other window, well known in the art, can be used to shape the signal. While depicted in the plane of the page, the array may exist on a two dimensional manifold in three dimensional space, or even in bulk three dimensional space. The window need no be a tensor outer product of two one dimensional windows, thus allowing various directional lines at various angles.

The window generator 230 is responsive to an output from a subject director 220 that subjects the suspect to stimulus that evokes the desired reaction or activity. The subject director 220 receives input from an Obedience Deficit Disorder Error generator, ODD ERR 212. ODD ERR 212 is responsive to an output from a security camera 210 by way of wireless link 211. The process of deriving an error signal is made possible by computer vision algorithms well known in the art. For example face recognition locates the suspect and a desired position of the suspect is calculated, so that subject director 220 is able to calculate a series of signals to provide to window generator 230, to bring the suspect into compliance.

Additionally, an error controller provides high outputs on multiple (preferably all of) stimulators 201 if the suspect attempts to remove garment 200 or tamper with garment 200. A low battery indicator provides gradually increasing stimulus on all of stimulators 201 as battery power decreases. The suspect being provided with a battery charger is, however, able to stop this gradually increasing electroshock therapy by simply plugging in the battery charger. Thus the suspect can sleep very comfortably next to an electrical outlet, and charge his or her prosthetic device.

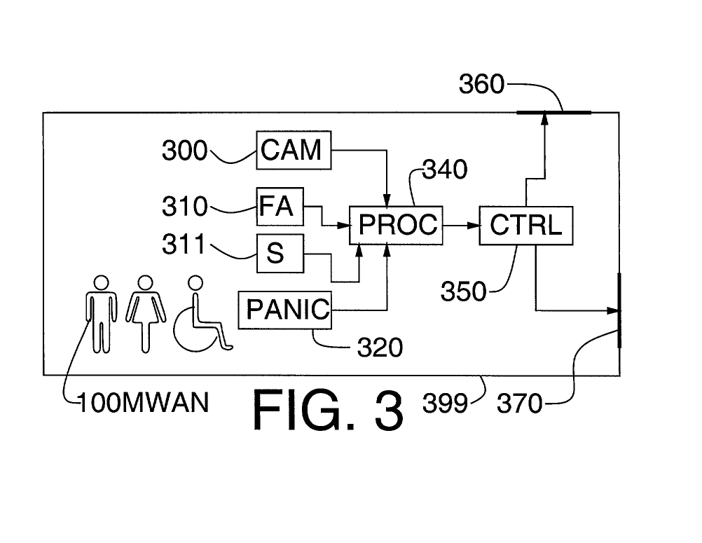

FIG. 3 is a diagram showing a disease outbreak containment system for a building 399 having emergency exits 360 and regularly used nonemergency exits 370. Emergency exits 360 are emergency exits unlocked by fire alarm, to prevent egress unless a fire alarm condition is present. Such exits might, for example, prevent persons, such as suspects 100MWAN from wandering out into the runway at an airport.

Regular usage of nonemergency exits 370 continues unless there is an alarm condition of a disease outbreak. A chemical agent monitor 300 might, for example, detect anthrax and lock nonemergency exits 370 to prevent egress. Thus both kinds of exits 360 and 370 will then be locked, so that suspects 100MWAN cannot flee from the incident scene until decontamination lines are established for collection of clothing and personal effects.

A processor 340 receives input from chemical agent monitor 300 to control the exit controller 350. The processor 340 can also accept input from panic buttons 320. For example, if there is a protest in the building 399, and a rally or riot ensues, an officer might notice some spilled white powder on a restaurant table, and the officer might not be certain whether the powder is anthrax or table salt. The officer can exit from the building while pressing the panic button to make sure that none of the protestors exit. The panic button will seal the perimeter of the building to prevent anyone from entering or leaving the incident scene.

Additionally, the processor 340 is responsive to a fire alarm 310 so that all exits can be unlocked by the fire alarm, but with the added requirement of evidence of real fire as detected by additional sensors 311.

Thus a problem of conflicting requirements (containment of disease and allowing egreess if fire) is resolved by changing the threshold of fire release sensitivity. Ordinarily just the fire alarm would allow egress, but if the disease panic button is hit first, the exits do not realease at a mere fire alarm, but require an actual fire to be opened. This prevents suspects from pulling the fire alarm to escape quarantine or decon.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations.

References to “processor”, or “computer” shall include sequential instruction, parallel instruction, and special purpose architectures such as digital signal processing hardware, Field Programmable Gate Arrays (FPGAs), programmable logic devices, as well as analog signal processing devices.

From the foregoing description, it will thus be evident that the present invention provides a design for a decontaminator with circumvention preventer. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

The embodiments of the invention in which I claim an exclusive property or privilege are defined as follows:

1. A self-booking station comprising:
at least one security camera;
at least one visual data capture device;
at least one personal effects receptacle,
at least a first image captured when a suspect initially enters said station, at least a second image captured when said suspect places a first personal effect in said receptacle, and at least a third image captured when said suspect places a last personal effect in said receptacle.

2. The self-booking station of claim 1, where said personal effects receptacle is equipped with a personal effects sensor, said visual data capture device responsive to an output of said personal effects sensor.

3. The self-booking station of claim 1, where said self first image is captured from said camera prior to the removal of said suspect's clothing, said camera being a first camera, said station including a second camera, said station equipped with a visual display for being visible to said suspect, said visual display for providing instructions for directing said suspect to:
reveal the contents of said suspect's pockets to a first scanning receptacle, said second image being an image from said second camera;
remove clothing to a second scanning receptacle, said third image then captured by said first camera.

4. The self-booking station of claim 1, where said personal effects receptacle is equipped with a personal effects scanner, said visual data capture device responsive to an output of said personal effects scanner, said scanner for capturing a scan of each article of clothing removed by said suspect, said scans stored and indexed together with a corresponding image of said suspect wearing said article of clothing.

5. The self-booking station of claim 1, where said personal effects are clothing, and said first personal effect is a first article of clothing, and said last personal effect is a last article of clothing.

6. The self-booking station of claim 1, further including at least one fingerprint scanner.

7. The self-booking station of claim 1, further including an electronic personal effects claim check issuer, said claim check issuer responsive to input from at least one biometric identifier.

8. The self-booking station of claim 7, where said biometric identifier is an eye scanner, said eye scanner also providing a health assessment of said suspect.

9. A method of allowing suspects to self-book, said method comprising the steps of:
allowing suspects to present themselves for being photographed in a multimedia booking kiosk;
providing suspects with computer-generated instructions for scanning of personal effects;
allowing suspects to remove some personal effects for scanning;
capturing at least one image of said personal effects;
capturing at least one additional image of said suspect.

10. The method of claim 9 further including the step of:
supplying at least one of said suspects with an obedience deficit disorder prosthetic;
providing said suspect with instructions for installation of said obedience deficit disorder prosthetic.

11. A self-booking system comprising:
at least one security camera;
at least one visual data capture device;
at least one conditional holding facility for prevention of escape of persons or their personal effects,
at least a first image captured when a suspect initially enters said system, said system having a fire sensor, a processor, and exit control device, said system having at least two levels of fire egress availabilty, a lesser level of fire egress availabilty, and a greater level of fire egress availabilty, said system also including a chemical agent monitor, said exit control device causing at least one exit to become less operable when said chemical agent monitor detects a chemical agent, said system selecting said lesser level of fire egress availabilty in response to an output from said chemical agent monitor.

12. The self-booking system of claim 11 where said system is within a building.

13. The self-booking system of claim 11 where said fire sensor comprises at least one fire pull station and at least one heat sensor.

14. The self-booking system of claim 11 where said system is within a building, said building equipped with decontamination dispenser activated by said chemical agent monitor.
